(19) United States
(12) Patent Application Publication
(10) Pub. No.: US 2025/0291409 A1
(43) Pub. Date: Sep. 18, 2025

(54) UTILIZING BLIND SPOT LOCATIONS TO PROJECT SYSTEM IMAGES

(71) Applicant: Microsoft Technology Licensing, LLC, Redmond, WA (US)

(72) Inventors: Michaela PORUBANOVA, Seattle, WA (US); Gregory Michael LINK, Charlotte, NC (US)

(73) Assignee: Microsoft Technology Licensing, LLC, Redmond, WA (US)

(21) Appl. No.: 18/603,090

(22) Filed: Mar. 12, 2024

(51) Int. Cl. G06F 3/01; G09G 3/00

(52) U.S. Cl. CPC G06F 3/013; G09G 3/001; G09G 2354/00

(57) ABSTRACT

One example provides a method enacted on a display device comprising an eye tracking system. The method comprises receiving, from the eye tracking system, eye tracking system data for an eye of a user of the display device. The method further comprises determining a blind spot location of a physiological blind spot of the eye of the user of the display device from the eye tracking system data. The method also comprises projecting a system image based at least in part on the blind spot location. The system image includes content related to operation of the display device.

### BACKGROUND

A head mounted display (HMD) device may display virtual reality (VR) content and/or augmented reality (AR) content utilizing a left projector and a right projector by projecting separate left and right display images. However, misalignment between the left projector and the right projector can cause a misalignment between the left and right display images, such as resulting from temperature changes and/or drift over time of the HMD device. This can cause divergence between the left and right eye images that can impact a user experience.

HMD devices with non-rigid frames may be more susceptible to misalignment between the images than HMD devices with rigid frames. To address such misalignment issues, some HMD devices utilize a display alignment tracker (DAT) system for monitoring alignment of the left projector and the right projector.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides a method enacted on a display device comprising an eye tracking system. The method comprises receiving, from the eye tracking system, eye tracking system data for an eye of a user of the display device. The method further comprises determining a blind spot location of a physiological blind spot of the eye of the user of the display device from the eye tracking system data. The method also comprises projecting a system image based at least in part on the blind spot location. The system image includes content related to operation of the display device.

### BRIEF DESCRIPTION OF THE DRAWINGS

FIG. 1 shows an example HMD device with an eye tracking system.

FIG. 2 schematically depicts an example configuration of illuminators of the eye tracking system of FIG. 1.

FIG. 3 schematically depicts an eye of the user of the HMD device of FIG. 1 from the perspective of an eye tracking camera of the eye tracking system.

FIG. 4 shows a schematic view of an eye.

FIGS. 5A and 5B schematically depict example left and right monocular images utilizing a blind spot location.

FIG. 6 shows a block diagram of an example display device.

FIG. 7 illustrates a flow diagram of an example method for utilizing a blind spot location to project a system image.

FIG. 8 depicts a block of an example computing system.

### DETAILED DESCRIPTION

As mentioned above, some HMD devices may utilize a DAT system to monitor alignment of a left projector and a right projector. Such DAT systems enable the HMD device to positionally adjust left eye images and/or right eye images to help reduce user discomfort. Current DAT systems utilize a camera to detect left side and right side fiducial images for monitoring the alignment of the left and right projectors. However, such fiducial images can be perceived by a user of the HMD device. As such, the fiducial images can be visually disruptive to the user. One possible solution is to project the fiducial images outside a field of view of the human visual system. However, current HMD devices have a field of view that is smaller than the field of view of the human visual system. Another possible solution is to filter the fiducial images from being perceived by the user using various hardware and/or software filtering techniques. However, such filtering techniques are challenging to develop. Further, the filtering may result in low precision for the DAT alignment detection and algorithms when the fiducial images have low visibility.

Accordingly, examples are disclosed that relate to utilizing a human blind spot location to project a system image. As used herein, the term “system image” represents an image that includes content related to operation of a display device, rather than an image with content intended for viewing. Briefly, the display device comprises an eye tracking system configured to track a pose of an eye of the user, and to provide eye tracking system data based upon the pose of the eye of the user. Further, the display device comprises a display system including a projector configured to project images intended to be viewed by the eye of the user. The display device determines the blind spot location of a physiological blind spot of the eye of the user from the eye tracking system data. The method then projects the system image based at least in part on the blind spot location. Such system images are intended to be consumed by the display device and not by the user. For example, the system image can include DAT fiducial images or other suitable perceptual visual perturbations. In some examples where the system image is smaller than a display area of the blind spot location, the system image can be projected within an angular field of view of the blind spot location. When the fiducial image is projected monocularly (e.g., for one eye), such a configuration helps to visually hide the system image from being perceived by the user. In this manner, the system image may be less distracting than an image outside of the angular field of view of the blind spot location.

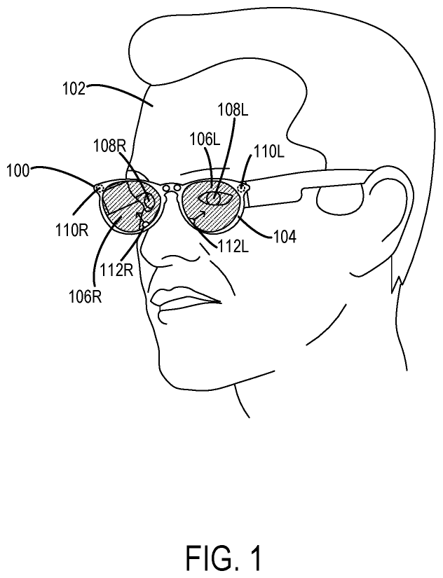

FIG. 1 shows an example HMD device 100 with an eye tracking system. The HMD device 100 comprises a display frame 104 configured to position left and right near-eye displays 106L, 106R in respective fields of view of a left eye 108L and a right eye 108R of the user 102. In some implementations, the HMD device 100 may take the form of a VR device that includes opaque, non-see-through near-eye displays. In other implementations, the HMD device 100 may take the form of an AR device that comprises at least partially transparent near-eye displays that are configured to enable the user 102 to view physical, real-world objects in a physical space through one or more partially transparent pixels displaying virtual object representations.

The HMD device 100 also comprises a display system for displaying images using the left and right near-eye displays 106L, 106R. More particularly, a left projector 110L is configured to project one or more images using the left near-eye display 106L such that the images are within a field of view of the left eye 108L. Examples of the left projector 110L include a liquid crystal on silicon (LCOS) micro display and a scanned beam projector. Similarly, a right projector 110R is configured to project one or more images using the right near-eye display 106R such that the images are in the field of view of the right eye 108R.

In the illustrated example, the HMD device 100 comprises an optional DAT system that utilizes left and right fiducial images to determine an alignment between the left projector 110L and the right projector 110R. As previously mentioned, display of the left and right fiducial images may be visually distracting to the user 102. As such, the HMD device 100 is configured to project the left fiducial image within a display location of a left blind spot location and the right fiducial image within a display location of a right blind spot location, as will be discussed in more detail below. In such a configuration, the left and right fiducial images can be detected by the HMD device 100, and thus not be perceived by the user 102. While discussed here with reference to left and right fiducial images for a DAT system, other suitable system images can be projected based upon the blind spot location, such as system images related to calibration and/or optimization of the HMD device 100.

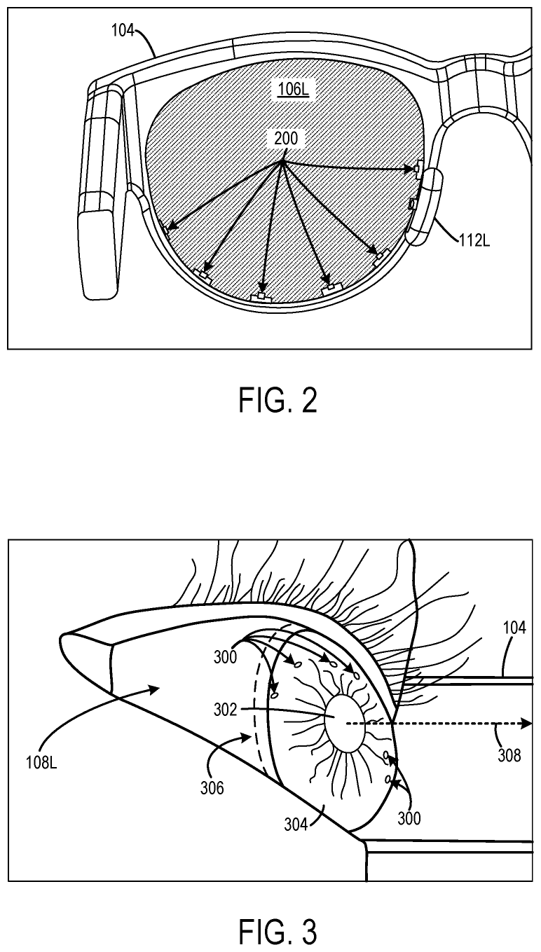

The HMD device 100 is configured to determine a blind spot location of a physiological blind spot of an eye of the user 102 from eye tracking system data. Therefore, the HMD device 100 comprises an eye tracking system for providing the eye tracking system data. Here, a left eye-tracking camera 112L is positioned on the display frame 104 to image the left eye 108L. The left eye-tracking camera 112L can include an infrared or another suitable camera. Additionally, the eye tracking system comprises a left plurality of illuminators 200 as illustrated in FIG. 2. Each illuminator is configured to emit infrared (IR) or near-infrared (NIR) illumination in a high-sensitivity wavelength band of the left eye-tracking camera 112L. Each illuminator may comprise a light-emitting diode (LED), diode laser, discharge illumination source, or another type of infrared illuminator. The left plurality of illuminators 200 are positioned on the display frame 104 to illuminate the left eye 108L, such as is depicted in FIG. 3 (from a perspective of the left eye-tracking camera 112L). Here, specular glints 300 are created by illumination emitted by the left plurality of illuminators 200 and reflected off of the cornea of the left eye 108L to perform eye-tracking of the left eye 108L. Similarly, the eye tracking system also comprises a right eye-tracking camera 112R and a right plurality of illuminators to perform eye tracking of the right eye 108R.

The eye-tracking operations of the HMD device 100 utilize the eye tracking system data, such as infrared images from the left eye-tracking camera 112L and/or the right eye-tracking camera 112R, for example. In one example, such image data may be processed to resolve various eye features including a center of the pupil 302, an outline of the pupil 302, an outline of the iris 304 and/or positions of the specular glints 300 reflected by the cornea 306. Further, the resolved locations of such eye features may be used as input parameters in a mathematical model (e.g., a polynomial model) that relates feature position to a gaze direction (depicted in FIG. 3 as a gaze direction 308). Such a mathematical model can be included in an eye model.

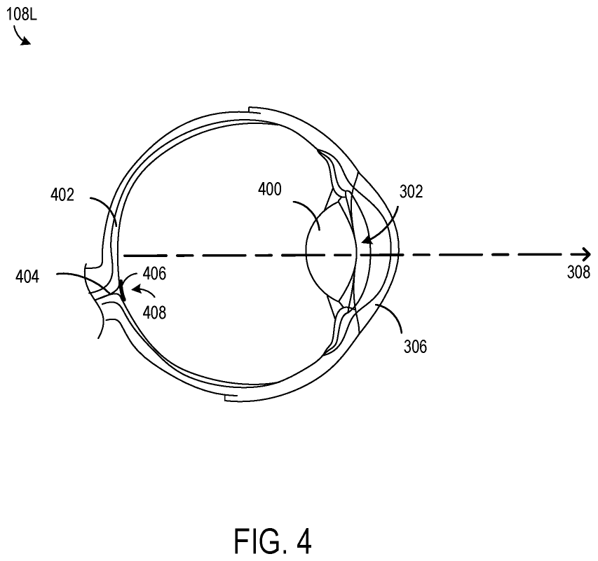

Additionally, the eye model can further include information relating to the anatomy of a human eye. This can help to infer a location of the physiological blind spot of the human eye. Such eye anatomy is schematically illustrated in FIG. 4. Here, a cross section of the left eye 108L is depicted for discussion. Incoming light passes through the cornea 306, the pupil 302, the lens 400, and onto the retina 402. Further, rods and cones on the retina 402 transduce the received light into electric pulses. These electric pulses are carried by the optic nerve 404 for visual processing. The location where the optic nerve 404 exits the eye is referred to as the optic disc 406. A physiological blind spot 408 results from the lack of rods and cones overlying the optic disc 406. Therefore, light hitting the optic disc 406 is not transduced for visual processing. For example, a portion of a monocular image received at the optic disc 406 is not perceived by the left eye 108L. Thus, the human visual system compensates for this lack of input from one eye. In contrast, binocular images may not have a perceivable blind spot as the human visual system can interpolate visual information in the physiological blind spot 408 from surrounding visual information from the retina 402 and/or visual information from the right eye 108R.

As mentioned above, a physiological blind spot of an eye can be inferred from the anatomy of the eye and a gaze direction of the eye. Generally, the center of the physiological blind spot corresponds to input in the temporal areas of the visual field and thus, in the nasal areas on the retina (e.g., about 12-16 degrees temporally from the gaze direction 308 and one to two degrees downward from the gaze direction 308). FIGS. 1, 2, 3, and 4 are illustrative. In other examples, an eye tracking system may have another configuration.

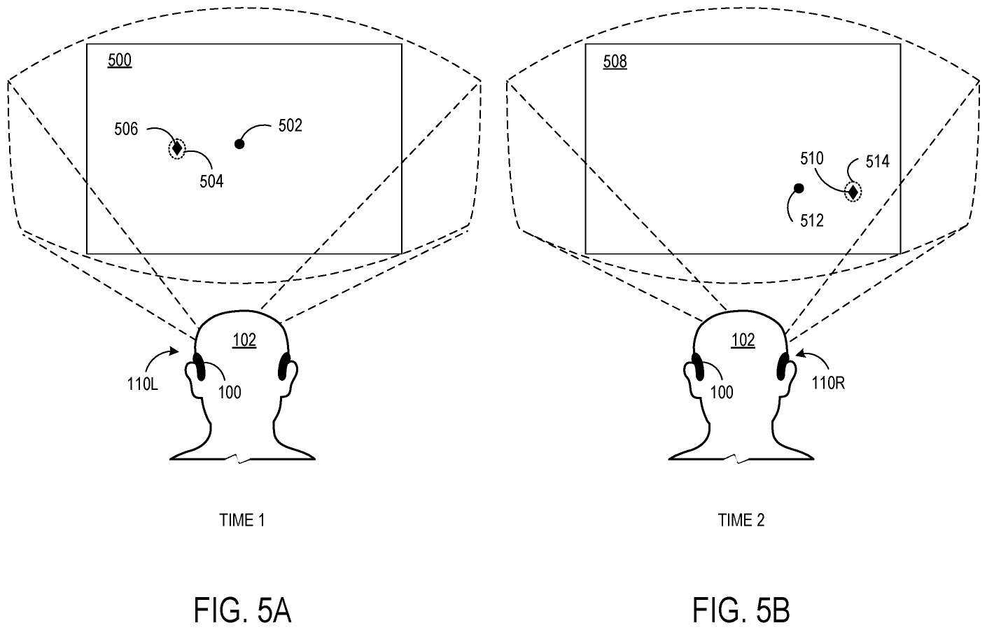

The HMD device 100 can utilize a DAT system for tracking alignment between the left projector 110L and the right projector 110R. FIGS. 5a and 5b schematically illustrate example monocular images utilizing corresponding blind spot locations. As depicted in FIG. 5a, the left projector 110L projects a left monocular image 500. Here, a gaze point 502 indicates a location along a gaze direction of the user 102. From the eye tracking system data, the HMD device 100 determines a left blind spot location 504 of the physiological blind spot of the left eye 108L. In one example, the left blind spot location 504 comprises a vertical visual angle around 7-8 degrees and a horizontal visual angle around 5-6 degrees.

As depicted, the left monocular image 500 includes a left system image 506 in the form of a fiducial image. Further, the left projector 110L projects the left system image 506 at a display location within an angular field of view of the left blind spot location 504. In such a configuration, the left system image 506 may not be perceived by the user 102 but can be detected by the HMD device 100. In a similar manner, the right projector 110R projects a right monocular image 508 including a right system image 510 as depicted in FIG. 5b. Here, the user 102 has changed the gaze location resulting in the right eye 108R having a gaze direction towards a gaze point 512. In response, the eye tracking system provides updated eye tracking system data, and the HMD device 100 determines a right blind spot location 514 from the updated eye tracking system data. In other examples, a system image can be split into multiple parts such that each part can be projected within an angular field of view of a blind spot location. FIGS. 5a and 5b are illustrative.

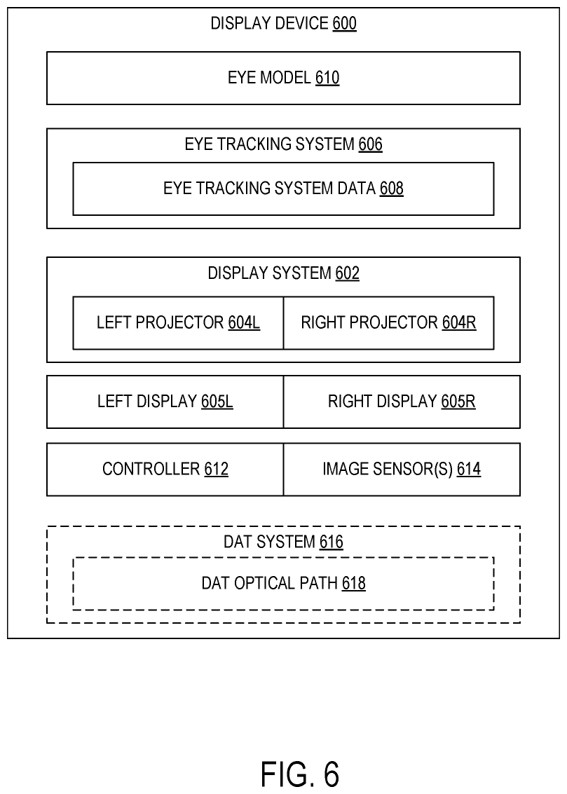

FIG. 6 shows a block diagram of an example display device 600. The HMD device 100 is an example implementation of the display device 600. The display device 600 comprises a display system 602 with a left projector 604L associated with a left eye of a user of the display device 600. The left projector 604L can include any suitable projector technologies including examples disclosed with the left projector 110L. Similarly, the display system 602 also comprises a right projector 604R associated with a right eye of the user. Further, the display system 602 is configured to project binocular images and/or monocular images. The binocular images are projected using both the left projector 604L and the right projector 604R, such as stereoscopic images, for example. The monocular images are projected by either the left projector 604L or the right projector 604R. In various examples, the left projector 604L and the right projector 604R can project different monocular images concurrently and/or a suitable combination of binocular images and monocular images. The display device 600 further comprises a left display 605L configured to transmit images from the left projector 604L for viewing. The left display 605L can be any suitable display technology, including the examples described with regard to the left near-eye display 106L. Similarly, the display device 600 also comprises a right display 605R.

Similar to the HMD device 100, the display device 600 comprises an eye tracking system 606 configured to provide eye tracking system data 608. In some examples, the eye tracking system 606 is configured is to determine a blind spot location and to provide the blind spot location as part of the eye tracking system data 608. In some such examples, the eye tracking system 606 can utilize an eye model 610 with a modeled blind spot location to determine the blind spot location. Alternatively, the eye tracking system 606 can be configured to specify a gaze direction of the eye in the eye tracking system data 608. In some such examples, the eye tracking system 606 can also provide an offset indicating the blind spot location relative to the gaze direction.

The display device 600 comprises a controller 612 for selectively controlling the display system 602. More particularly, the controller 612 is configured to selectively control the left projector 604L and the right projector 604R to project a system image based at least in part on the blind spot location of each of the left eye and right eye respectively. As previously mentioned, the system image includes content related to operation of the display device 600. In some examples where the eye tracking system 606 provides the blind spot location as part of the eye tracking system data 608, the controller 612 is configured to apply the offset to the gaze direction to compute the blind spot location. In some examples, the controller 612 is further configured to determine a display location that is within an angular field of view of the blind spot location and to selectively control the left projector 604L and/or the right projector 604R to project the system image within the display location. In further examples, the controller 612 may determine which projector to control for projecting the system image. As a specific example, the gaze direction may indicate that the user of the display device 600 is looking towards the right and therefore, determine to control the left projector 604L to project the system image.

The controller 612 is also configured to use one or more image sensors 614 to detect the system image to obtain operation data of the display device 600. Additionally, the controller 612 can be configured to adjust the operation of the display device 600 based at least upon the operation data. Examples of the operation of the display device 600 include optimization tasks and calibrations tasks. A specific example of an optimization task is a display optimization task. In such an example, the display device 600 can comprise an optional display alignment tracker (DAT) system 616 comprising a DAT optical path 618 indicative of an alignment of the left projector 604L and the right projector 604R. For example, the DAT optical path 618 includes a path from the left projector 104L through the left display 605L to the image sensor 614 and a path from the right projector 104R through the right display 605L to the same image sensor 614. In such an example, the image 614 can be located between the left display 605L and the right display 605L. Additionally, the controller 612 can be configured to control the left projector 604L and/or the right projector 604R to selectively project the system image based at least in part on a blind spot location determined from the eye tracking system data 608 along the DAT optical path 618. Here, the system image can be in the form of a fiducial image and projected at a display location that is within an angular field of view of the blind spot location. Further, the controller 612 can be configured to adjust a display location of stereoscopic images based at least upon the fiducial image detected by the image sensor 614, and thus, perform the display optimization task such that the fiducial image is not perceived by the user of the display device 600. In some such examples, the controller 612 can be configured to project the fiducial image using the left projector 604L and the right projector 604R in a time multiplexed manner. While discussed here with reference to a DAT system and a display optimization task, another system task can utilize a blind spot location for projecting a system image in other examples.

As another example, the display device 600 can be configured to determine an actual blind spot location of the physiological blind spot of the eye of the user. As a more specific example, the display device 600 can perform a calibration method in which a test image is projected within an approximate display location of the blind spot location. Further, the calibration method can instruct the user to gaze at a specified gaze spot and request an input indicating whether the user can see the test image while gazing at the gaze spot. The calibration method can determine a boundary of the actual blind spot location by adjusting the display location of the test image based upon the input, and requesting additional input(s) indicating whether the user can see the test image at the additional display locations. Based at least upon a border between a location at which a user can see the test image and a location at which the user cannot see the test image, a location on a boundary of the user's blind spot can be located. Other locations on the boundary can be identified similarly. In such a manner, the display device 600 can determine a blind spot boundary at least upon the actual blind spot, and then display system images in the determined blind spot.

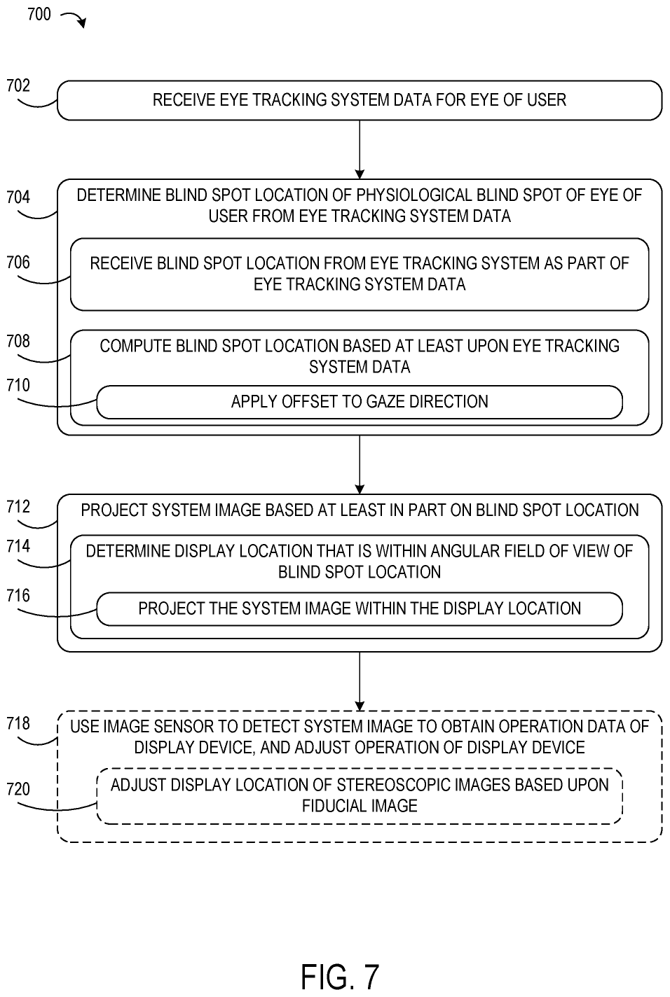

FIG. 7 illustrates a flow diagram of an example method 700 for utilizing a blind spot location to project system images. Method 700 can be performed by any suitable display device comprising an eye tracking system. Examples include HMD device 100 and display device 600. Method 700 comprises, at 702, receiving, from the eye tracking system, eye tracking system data for an eye of a user of the display device. In some examples, the eye tracking system data can include left eye tracking system data for a left eye of the user and right tracking system data for a right eye of the user. Method 700 further comprises, at 704, determining a blind spot location of a physiological blind spot of the eye of the user of the display device from the eye tracking system data. In some examples, method 700 may determine a left blind spot location associated with the left eye and/or a right blind spot location associated with the right eye. Determining the blind spot location can comprise receiving the blind spot location from the eye tracking system as part of the eye tracking system data as indicated at 706. In some such examples, the eye tracking system can utilize an eye model with a modeled blind spot location to determine the blind spot location. Alternatively or additionally, determining the blind spot location can comprise computing the blind spot location based at least upon the eye tracking system data as indicated at 708. In some such examples, the eye tracking system data can specify a gaze direction of the eye. In such examples, method 700 can comprise, at 710, applying an offset to the gaze direction to compute the blind spot location.

Continuing, method 700 comprises, at 712, projecting a system image based at least in part on the blind spot location. As previously mentioned, the system image includes content related to operation of the display device, such as optimization tasks and calibration tasks, for example. In some examples, projecting the system image based at least in part on the blind spot location comprises determining a display location that is within an angular field of view of the blind spot location as indicated at 714. Further in some such examples, projecting the system image based at least in part on the blind spot location comprises projecting the system image within the display location as indicated at 716.

Method 700 can additionally comprise, at 718, using an image sensor to detect the system image to obtain operation data of the display device, and adjusting the operation of the display device based at least upon the operation data. As a specific example, a display optimization task can utilize a system image in the form of one or more fiducial images. In such examples, adjusting the operation of the display device comprises adjusting a display location of stereoscopic images based upon the fiducial images detected as indicated at 720. In some such examples, the fiducial images may be projected in a time multiplexed manner. This can help the display device to address misalignment between a left projector and a right projector on the display device. In such a manner, the user may not perceive the fiducial image as the display device tracks the alignment of the left and right projectors. In other examples, 718 and/or 720 may be omitted.

Utilizing a blind spot location to project a system image as disclosed herein can enable a display device to perform system operations in such a manner that the system image is not perceived by a user of the display device. This may help to reduce visual distraction resulting from the system image projection over a system image that is projected outside a field of view of the blind spot location.

In some examples, the methods and processes described herein may be tied to a computing system of one or more computing devices. In particular, such methods and processes may be implemented as a computer-application program or service, an application-programming interface (API), a library, and/or other computer-program product.

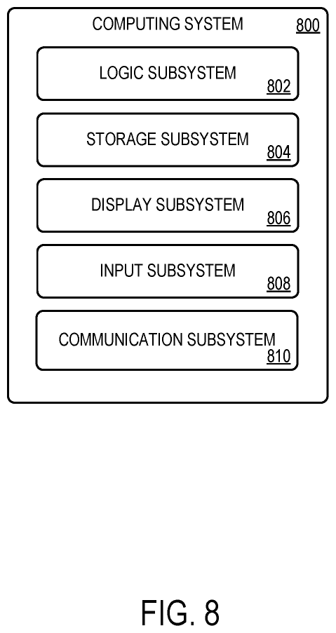

FIG. 8 schematically shows aa block diagram of an example computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices. The HMD device 100 and the display device 600 are examples of computing system 800.

Computing system 800 includes a logic subsystem 802 and a storage subsystem 804. Computing system 800 may optionally include a display subsystem 806, input subsystem 808, communication subsystem 810, and/or other components not shown in FIG. 8.

Logic subsystem 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 804 includes one or more physical devices configured to hold instructions executable by the logic machine to implement the methods and processes described herein. When such methods and processes are implemented, the state of storage subsystem 804 may be transformed—e.g., to hold different data.

Storage subsystem 804 may include removable and/or built-in devices. Storage subsystem 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 804 may include volatile, nonvolatile, dynamic, static, read/write, read-only, random-access, sequential-access, location-addressable, file-addressable, and/or content-addressable devices.

It will be appreciated that storage subsystem 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 802 and storage subsystem 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic subsystem 802 executing instructions held by storage subsystem 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 806 may be used to present a visual representation of data held by storage subsystem 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic subsystem 802 and/or storage subsystem 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

One example provides a method on a display device comprising an eye tracking system. The method comprises receiving, from the eye tracking system, eye tracking system data for an eye of a user of the display device, and determining a blind spot location of a physiological blind spot of the eye of the user of the display device from the eye tracking system data. The method further comprises projecting a system image based at least in part on the blind spot location. The system image includes content related to operation of the display device. In some such examples, determining the blind spot location alternatively or additionally comprises receiving the blind spot location from the eye tracking system as part of the eye tracking system data. In some such examples, the eye tracking system alternatively or additionally utilizes an eye model with a modeled blind spot location. In some such examples, determining the blind spot location alternatively or additionally comprises computing the blind spot location based at least upon the eye tracking system data. In some such examples, the eye tracking system data alternatively or additionally specifies a gaze direction of the eye, and computing the blind spot location based at least upon the eye tracking system data alternatively or additionally comprises applying an offset to the gaze direction. In some such examples, projecting the system image based at least in part on the blind spot location alternatively or additionally comprises determining a display location that is within an angular field of view of the blind spot location. In some such examples, projecting the system image based at least in part on the blind spot location alternatively or additionally comprises projecting the system image within the display location. In some such examples, the method alternatively or additionally comprises using an image sensor to detect the system image to obtain operation data of the display device, and adjusting the operation of the display device based at least upon the operation data. In some such examples, the system image alternatively or additionally includes a fiducial image, and adjusting the operation of the display device alternatively or additionally comprises adjusting a display location of stereoscopic images based upon the fiducial image.

Another example provides a display device comprising an eye tracking system configured to provide eye tracking system data for an eye of a user of the display device, a display system comprising a projector associated with the eye of the user, and a controller configured to control the projector to selectively project a system image based at least in part on a blind spot location determined from the eye tracking system data. In some such examples, the eye tracking system is alternatively or additionally configured to determine the blind spot location using an eye model with a modeled blind spot location and to provide the blind spot location as part of the eye tracking system data. In some such examples, the controller is alternatively or additionally configured to determine the blind spot location from the eye tracking system data. In some such examples, the eye tracking system data alternatively or additionally specifies a gaze direction, and determining the blind spot location from the eye tracking system data alternatively or additionally comprises applying an offset to the gaze direction. In some such examples, the controller is alternatively or additionally configured determine a display location that is within an angular field of view of the blind spot location. In some such examples, the controller is alternatively or additionally configured to control the projector to selectively project the system image by controlling the projector to project the system image within the display location. In some such examples, the projector alternatively or additionally is a left projector associated with a left eye of the user, the system image is alternatively or additionally a fiducial image, the display system alternatively or additionally comprises a right projector associated with a right eye of the user, the display device alternatively or additionally comprises a display alignment tracker (DAT) system comprising a DAT optical path indicative of an alignment of the left projector and the right projector, and the controller is alternatively or additionally configured to control the projector to selectively project the system image by controlling one or more of the left projector or the right projector to selectively project the fiducial image along the DAT optical path based at least in part on the eye tracking system data.

Another example provides a head mounted display (HMD) device comprising an eye tracking system configured to provide eye tracking system data for one or more of a left eye or a right eye of a user of the HMD device, a display system comprising a left projector associated with the left eye and a right projector associated with the right eye, a display alignment tracker (DAT) system comprising a DAT optical path indicative of an alignment of the left projector and the right projector, and a controller configured to selectively control one or more of the left projector or the right projector to project, along the DAT optical path, a system image based at least in part on a blind spot location determined from the eye tracking system data. In some such examples, the eye tracking system is alternatively or additionally configured to determine the blind spot location using an eye model with a modeled blind spot location, and to provide the blind spot location as part of the eye tracking system data. In some such examples, the controller is alternatively or additionally configured to determine the blind spot location from the eye tracking system data. In some such examples, selectively controlling the one or more of the left projector or the right projector to project the system image alternatively or additionally comprises determining a display location that is within an angular field of view of the blind spot location, and controlling the one or more of the left projector or the right projector to selectively project the system image within the display location.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. On a display device comprising an eye tracking system, a method comprising:
receiving, from the eye tracking system, eye tracking system data for an eye of a user of the display device;
determining a blind spot location of a physiological blind spot of the eye of the user of the display device from the eye tracking system data; and
projecting a system image based at least in part on the blind spot location, the system image including content related to operation of the display device.

2. The method of claim 1, wherein determining the blind spot location comprises receiving the blind spot location from the eye tracking system as part of the eye tracking system data.

3. The method of claim 2, wherein the eye tracking system utilizes an eye model with a modeled blind spot location.

4. The method of claim 1, wherein determining the blind spot location comprises computing the blind spot location based at least upon the eye tracking system data.

5. The method of claim 4, wherein the eye tracking system data specifies a gaze direction of the eye, and wherein computing the blind spot location based at least upon the eye tracking system data comprises applying an offset to the gaze direction.

6. The method of claim 1, wherein projecting the system image based at least in part on the blind spot location comprises determining a display location that is within an angular field of view of the blind spot location.

7. The method of claim 6, wherein projecting the system image based at least in part on the blind spot location comprises projecting the system image within the display location.

8. The method of claim 1, further comprising using an image sensor to detect the system image to obtain operation data of the display device, and adjusting the operation of the display device based at least upon the operation data.

9. The method of claim 8, wherein the system image includes a fiducial image, and adjusting the operation of the display device comprises adjusting a display location of stereoscopic images based upon the fiducial image.

10. A display device comprising:
an eye tracking system configured to provide eye tracking system data for an eye of a user of the display device;
a display system comprising a projector associated with the eye of the user; and
a controller configured to control the projector to selectively project a system image based at least in part on a blind spot location determined from the eye tracking system data.

11. The display device of claim 10, wherein the eye tracking system is configured to determine the blind spot location using an eye model with a modeled blind spot location and to provide the blind spot location as part of the eye tracking system data.

12. The display device of claim 10, wherein the controller is further configured to determine the blind spot location from the eye tracking system data.

13. The display device of claim 12, wherein the eye tracking system data specifies a gaze direction, and wherein determining the blind spot location from the eye tracking system data comprises applying an offset to the gaze direction.

14. The display device of claim 10, wherein the controller is configured determine a display location that is within an angular field of view of the blind spot location.

15. The display device of claim 14, wherein the controller is configured to control the projector to selectively project the system image by controlling the projector to project the system image within the display location.

16. The display device of claim 15, wherein
the projector is a left projector associated with a left eye of the user,
the system image is a fiducial image,
the display system further comprises a right projector associated with a right eye of the user,
the display device further comprises a display alignment tracker (DAT) system comprising a DAT optical path indicative of an alignment of the left projector and the right projector, and
the controller is configured to control the projector to selectively project the system image by controlling one or more of the left projector or the right projector to selectively project the fiducial image along the DAT optical path based at least in part on the eye tracking system data.

17. A head mounted display (HMD) device comprising:
an eye tracking system configured to provide eye tracking system data for one or more of a left eye or a right eye of a user of the HMD device;
a display system comprising a left projector associated with the left eye and a right projector associated with the right eye;
a display alignment tracker (DAT) system comprising a DAT optical path indicative of an alignment of the left projector and the right projector; and
a controller configured to selectively control one or more of the left projector or the right projector to project, along the DAT optical path, a system image based at least in part on a blind spot location determined from the eye tracking system data.

18. The HMD device of claim 17, wherein the eye tracking system is configured to determine the blind spot location using an eye model with a modeled blind spot location, and to provide the blind spot location as part of the eye tracking system data.

19. The HMD device of claim 17, wherein the controller is further configured to determine the blind spot location from the eye tracking system data.

20. The HMD device of claim 17, wherein selectively controlling the one or more of the left projector or the right projector to project the system image comprises determining a display location that is within an angular field of view of the blind spot location, and controlling the one or more of the left projector or the right projector to selectively project the system image within the display location.
